(19) United States
(12) Patent Application Publication
(10) Pub. No.: US 2007/0286221 A1
(43) Pub. Date: Dec. 13, 2007

(54) Memory management method and memory architecture for transmitting UWB PCA frames

(76) Inventors: Mau-Lin Wu, Hsinchu City (TW); Tung-Hui Lee, Jhubei City (TW); Chieh-Hua Chen, Taipei City (TW); Hsin-Pu Chung, Taipei City (TW); Youn-Tai Lee, Yonghe City (TW)

Correspondence Address: J. C. Patents, Inc., Suite 250, 4 Venture, Irvine, CA, 92618, US

(21) Appl. No.: 11/452,791

(22) Filed: Jun. 13, 2006

(51) Int. Cl. H04L 12/56; H04J 3/02

(52) U.S. Cl. 370/412; 370/462

(57) ABSTRACT

A memory management method and a memory architecture for transmitting ultra-wideband (UWB) prioritized channel access (PCA) frames are provided. The method comprises the steps of assigning a pre-load queue to each of a plurality of access categories for storing UWB PCA frames to be transmitted, and, when one of the access categories gains transmission opportunity (TXOP), assigning a common area queue to that access category for storing UWB PCA frames to be transmitted. Moreover, when a UWB PCA frame in one of the pre-load queues reaches a predetermined size, the access category corresponding to the pre-load queue starts its backoff state machine in order to gain the TXOP.

### BACKGROUND OF THE INVENTION

1. Field of the Invention

The present invention relates to a memory management method and a memory architecture for network data communication. More particularly, the present invention relates to a memory management method and a memory architecture for transmitting ultra-wideband (UWB) prioritized channel access (PCA) frames.

2. Description of the Related Art

In data communication systems, the feature of Quality of Service (QoS) is more and more important due to the popular triple-play (data, audio and video) application on internet and any other popular networks. In triple-play applications, not only data transfer is important for data communication system, audio (or speech) and video streaming are also very important. For audio and video streaming, in addition to throughput and reliability, other performance features are required. Among them, transmission latency and constantly stable bandwidth requirement are critical to multimedia applications. Therefore, QoS becomes more and more important in modern communication systems, which is applied for audio and video streaming.

Because the UWB standard is defined by WiMedia Alliance for transmission of not only data, but also audio and video streaming, PCA type transmission is provided to improve QoS of the system when transmitting audio and video. This PCA protocol prioritizes different UWB frame transmission through categorizing frame transmission into four different access categories (ACs). The channel access method of PCA is carrier sense multiple access with collision avoidance (CSMA/CA), which applies back-off timers to gain transmission opportunity (TXOP) for traffic transmission (TX). Through different channel access parameters, frames of different ACs have different probabilities for them to gain TXOP. Therefore, these frames have different priorities to access the channel.

A traditional memory architecture 100 of PCA TX queues are shown in FIG. 1. Four individual queues 110-113 are implemented for four access categories, namely, AC0-AC3. Frames from AC0, which are Frame0,0, Frame0,1, Frame0,2, and Frame0,3, are stored in the AC0 TX queue 110 before these frames are transmitted to the physical layer (PHY). There are similar cases for the AC1, AC2, and AC3 TX queues 111-113. In this example, there are no frames to be transmitted for AC2. Therefore, the AC2 TX queue 112 is empty. The frames stored in the AC TX queues will not be transmitted to PHY unless they are allowed to.

The conventional approach in FIG. 1 needs to implement four different TX queues in hardware. Since the maximal frame length of a UWB media access control (MAC) sublayer frame is 4 KB and the size of each queue is required to be at least double as large as a maximal UWB MAC frame, the total size of the four queues 110-113 is at least 32 KB. 32 KB SRAM implemented inside a chip is a large cost. Therefore it is desirable to reduce the hardware implementation cost of PCA TX queues without degradation of system performance. This is not a new problem to network data communication.

There are already three patents filed for solving similar multiple queue problems. U.S. Pat. No. 5,426,639 proposed one single memory designed for multiple queues requirements. The drawbacks of this patent are two folds. Firstly, if one of the four ACs has a lot of frames stored in the queue, but without gaining the TXOP, and the queue is nearly full, frames of the other ACs may be blocked and cannot be transmitted even when they gain the TXOP. This is one of the problems that tend to happen when PCA uses such a memory architecture. Secondly, the size of each block in this patent is fixed, which is good for specific applications with the property that most frames have the same size. But it is not appropriate for PCA since the frame lengths vary for different applications.

The idea of U.S. Pat. No. 6,044,418 is adopting queues with variable sizes and dynamically allocating the partition boundary of the queues, which are designed to be shared by different requesters at the same time. This patent has several drawbacks. There are constraints to the time of moving the partition boundary. It's difficult to predict the throughput requirements of each requester and it's also difficult to dynamically reallocate the partition boundary when a queue is being used. Memory utilization rate is not good. Moreover, implementation of dynamic partition boundary assignment is complex and requires large cost.

The idea of U.S. Pat. No. 6,154,800 is using a single address queue for handling multiple priority requests and using input address list pointer and output address pointer to indicate which addresses are occupied or vacant. The drawbacks of this patent are similar to those of U.S. Pat. No. 5,426,639.

### SUMMARY OF THE INVENTION

Accordingly, the present invention is directed to a memory management method for transmitting UWB PCA frames. The method reduces hardware implementation cost of PCA queues without performance impact.

The present invention is also directed to a memory architecture for transmitting UWB PCA frames. The memory architecture reduces queue memory size without performance impact.

According to an embodiment of the present invention, a memory management method for transmitting UWB PCA frames is provided. The method comprises the steps of assigning a pre-load queue to each of a plurality of access categories for storing UWB PCA frames to be transmitted, and, when one of the access categories gains TXOP, assigning a common area queue to that access category for storing UWB PCA frames to be transmitted.

In an embodiment of the present invention, when a UWB PCA frame in one of the pre-load queues reaches a predetermined size, the access category corresponding to the pre-load queue starts its backoff state machine in order to gain the TXOP.

In an embodiment of the present invention, when one of the access categories loses the TXOP, the method further comprises the steps of discarding the UWB PCA frames stored in the common area queue, and that access category releasing the common area queue.

In an embodiment of the present invention, the method determines the sizes of the pre-load queues and the common area queue according to the throughputs of the producer and the consumer of the UWB PCA frames.

According to another embodiment of the present invention, a memory architecture for transmitting UWB PCA frames is provided. The memory architecture comprises a plurality of pre-load queues and a common area queue. Each of the pre-load queues is assigned to a corresponding access category for storing UWB PCA frames to be transmitted. Furthermore, when one of the access categories gains the TXOP, the common area queue is assigned to that access category for storing UWB PCA frames to be transmitted.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a traditional memory architecture for transmitting UWB PCA frames.

FIG. 2 is a schematic diagram showing a memory architecture for transmitting UWB PCA frames according to an embodiment of the present invention.

FIG. 3 is a block diagram showing a hardware implementation of PCA TX queues according to an embodiment of the present invention.

FIG. 4 is a flow chart showing a typical scenario of transmitting UWB PCA frames according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The main idea of the present invention is to design innovative multiple queues with smaller memory requirement and at the same time without performance degradation.

According to the PCA protocol, each access category (AC) tries to gain TXOP following the CSMA/CA rules defined by the WiMedia UWB MAC specification. There is one important property in CSMA/CA rules. If an AC gains the TXOP, the AC can use the communication channel exclusively and is allowed to transmit frames continuously until the end of the TXOP. This property is the key point of the present invention.

FIG. 2 is a schematic diagram showing the pre-load memory architecture 200 according to an embodiment of the present invention. The memory architecture 200 is proposed in order to reduce the total size of the AC queues and make good use of the property of the CSMA/CA rules mentioned above. The memory of the architecture 200 is partitioned into five blocks, namely, AC0 pre-load queue 210, AC1 pre-load queue 211, AC2 pre-load queue 212, AC3 pre-load queue 213 and common area queue 220.

Initially, each of the pre-load queues 210-213 is assigned to a corresponding access category (AC0-AC3) for storing UWB PCA frames to be transmitted. When no access category gains TXOP, each access category is only allowed to store frames in its corresponding pre-load queue. AC0 is only allowed to store frames in the pre-load queue 210. AC1 is only allowed to store frames in the pre-load queue 211, and so on. When one of the access categories gains the TXOP, the common area queue 220 is assigned to that access category for storing UWB PCA frames to be transmitted. For example, if AC1 gains TXOP, the common area queue 220 is assigned to be used by AC1. Then AC1 has the access right to the common area queue 220 until another AC at the same device gains TXOP. When AC1 loses TXOP, AC1 loses the access right to the common area queue 220. In response, AC1 discards the frames stored in the common area queue 220 and then releases the common area queue 220. The discarded frames can be moved again from host memory later.

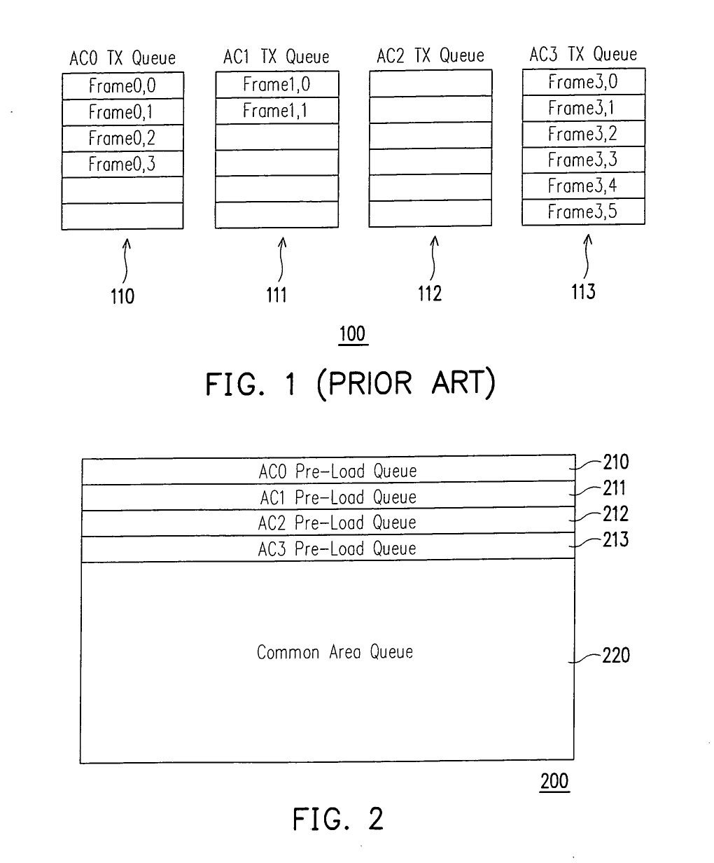

By this approach, the total size of the pre-load queues and the common area queue can be smaller than the total size of traditional TX queues, and there is no performance impact on the queues of the present invention. For example, if the size of each pre-load queue 210-213 is 1 KB and the size of the common area queue 220 is 7 KB. The total memory size is 11 KB, which is far smaller than the 32 KB size of the conventional memory architecture 100 in FIG. 1. This means 66% reduction in memory size and dramatically lowered hardware implementation cost. When an access category gains TXOP, there is a pre-load queue (1 KB) and the common area queue (7 KB) for storing frames. That is a total size of 8 KB, which is the same as that of a conventional TX queue. Therefore, the throughput performance of the memory architecture 200 is the same as that of the conventional architecture 100.

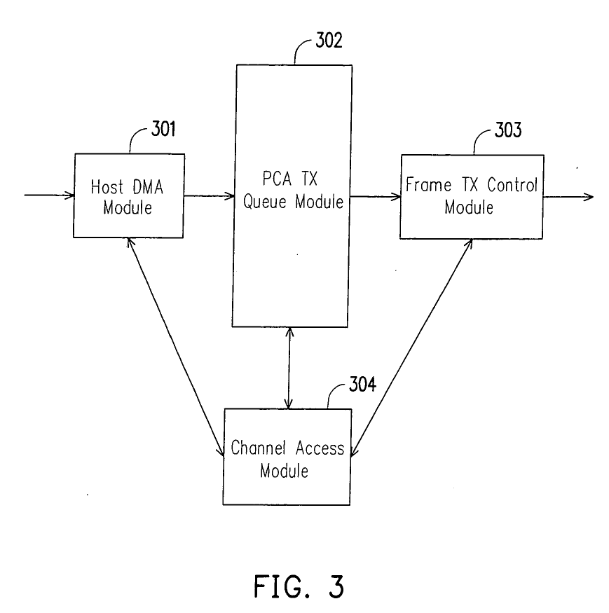

FIG. 3 is a block diagram showing a hardware implementation of PCA TX queues according to an embodiment of the present invention. The frames of each access category, which are located at the host memory, are moved from host memory to the corresponding queues in the PCA TX queue module 302 through the host direct memory access (DMA) module 301. The PCA TX queue module 302 implements the pre-load queues and the common area queue for the access categories. The channel access module 304 controls frame transmission by judging which AC has the authority to use the communication channel, which means that the PCA frames belonging to that AC are permitted for transmission. Frames in the PCA TX queues (the pre-load queues and the common area queue) are transmitted through the frame TX control module 303. The frame TX control module 303 is also controlled by the channel access module 304.

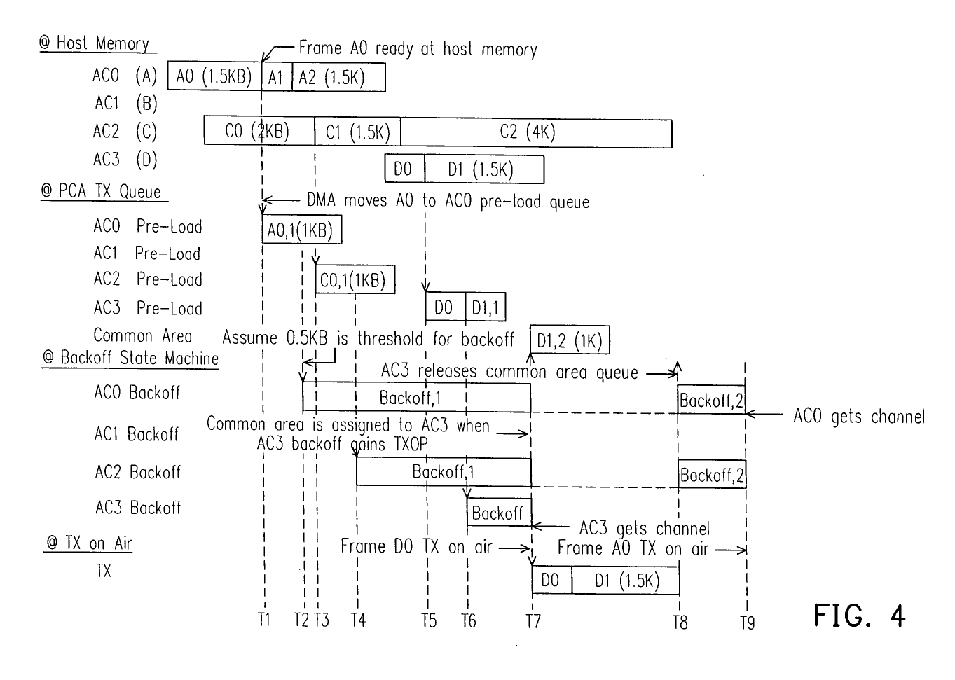

FIG. 4 is a schematic diagram showing a typical scenario in this embodiment. There are nine time points T1-T9 marking important moments along the time sequence of events in FIG. 4. AC0-AC3 are the four PCA access categories.

At moment T1, frame A0 of AC0 is ready for transmission at the host memory allocated for AC0 and begins to be moved by DMA into the AC0 pre-load queue. In this scenario, each pre-load queue has a size of 1 KB. Therefore the AC0 pre-load queue can only store the first 1 KB segment A0,1 of frame A0.

At moment T2, frame segment A0,1 in the AC0 pre-load queue has reached the predetermined size threshold (0.5 KB) for backoff, and AC0 starts its backoff state machine in order to gain the TXOP. The predetermined size threshold has to be smaller than the individual size of the pre-load queues and is adjustable according to specific requirements of an application. Such an early backoff ensures an access category can get the TXOP and transmit its frames sooner. Consequently the throughput is improved and the pre-load queues can be smaller to reduce total cost.

At moment T3, frame C0 of AC2 is ready for transmission at the host memory of AC2 and the host DMA module begins moving frame C0 into the AC2 pre-load queue. At moment T4, frame C0 reaches the predetermined size threshold of 0.5 KB and AC2 starts its backoff state machine for gaining the TXOP. At moment T5, frame D0 of AC3 is ready for transmission at the host memory of AC3 and the host DMA module begins moving frame D0 into the AC3 pre-load queue. At moment T6, frame D0 reaches the predetermined size threshold and AC3 also starts its backoff state machine. Now there are three access categories (AC0, AC2 and AC3) competing for the TXOP.

At moment T7, AC3 gains the TXOP, gains access to the communication channel, and therefore is allowed to store frames in the common area queue. Access categories AC0 and AC2 suspend their backoff state machines. The host DMA module begins moving frame segment D1,2 into the common area queue. Frames D0 and D1 begin their sequential transmission on air. Note that, before transmission, frame D1 is split into two segments D1,1 and D1,2. D1,1 is stored in the AC3 pre-load queue and D1,2 is stored in the common area queue. Both the AC3 pre-load queue and the common area queue are available to AC3 for storing frames as long as AC3 is still holding the TXOP.

At moment T8, AC3 loses the TXOP, stops frame transmission, releases the communication channel, and releases the common area queue. Access categories AC0 and AC2 resume their backoff state machines. At moment T9, AC0 gains the TXOP and access to the communication channel. Frame A0 begins its transmission on air.

The pre-load queues and the common area queue in this embodiment reside in the MAC sublayer, and the frames are transmitted to the physical layer. When applicable, the memory architecture and the memory management method of the present invention can be applied to other layers and/or other architectures as well.

The memory architecture in this embodiment works because actual buffering is needed only when an access channel gains the TXOP. Therefore a single common area queue is sufficient. The pre-load queues are mandatory because frames must be readily available in a corresponding pre-load queue when an access category gains the TXOP. Otherwise the frames have to be moved from host memory to the pre-load queue and there will be performance impact resulting from an idle period in the communication channel. Or even worse, the idle channel may be occupied by some access category of another device. In such a case, collision may occur and will not be detected until timeout.

In the scope of the present invention, the sizes of the pre-load queues and the common area queue can be adjusted according to different bus architectures between the host memory and the queues. Trade-off between cost and performance are also a reason for queue size adjustment. Larger queues deliver better performance and require higher cost.

The queue sizes can also be determined according to the throughputs of the producer (for example, the host device) and the consumer (for example, the physical layer) of the UWB PCA frames. Larger queues are required for sufficient buffering if the producer is slower. On the other hand, if the producer is fast enough, the queues can be implemented smaller.

In summary, the present invention achieves smaller total queue size and lower hardware implementation cost by sharing a single common area queue among all PCA access categories. Furthermore, the present invention provides pre-load queues for initial buffering when an access category gains the TXOP to prevent idle periods in the communication channel. As a result, the present invention introduces no performance impact compared to the conventional memory architecture.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory management method for transmitting ultra-wideband (UWB) prioritized channel access (PCA) frames, comprising:
assigning a pre-load queue to each of a plurality of access categories for storing UWB PCA frames to be transmitted; and
when one of the access categories gains a transmission opportunity (TXOP), assigning a common area queue to that access category for storing UWB PCA frames to be transmitted.

2. The method of claim 1, further comprising:
when a UWB PCA frame in one of the pre-load queues reaches a predetermined size, the access category corresponding to the pre-load queue starting its backoff state machine in order to gain the TXOP.

3. The method of claim 2, wherein the predetermined size is smaller than the individual size of the pre-load queues.

4. The method of claim 1, further comprising:
when one of the access categories gains the TXOP, starting transmission of the UWB PCA frames of that access category.

5. The method of claim 4, further comprising:
stopping transmission of the UWB PCA frames of that access category when that access category loses the TXOP.

6. The method of claim 1, further comprising the following steps when one of the access categories loses the TXOP:
discarding the UWB PCA frames stored in the common area queue; and
that access category releasing the common area queue.

7. The method of claim 1, further comprising:
determining the sizes of the pre-load queues and the common area queue according to the throughputs of a producer and a consumer of the UWB PCA frames.

8. The method of claim 1, wherein the method is applied in a media access control (MAC) sublayer.

9. The method of claim 8, wherein the UWB PCA frames are to be transmitted to a physical layer.

10. A memory architecture for transmitting ultra-wideband (UWB) prioritized channel access (PCA) frames, comprising:
a plurality of pre-load queues, wherein each of the pre-load queues is assigned to a corresponding access category for storing UWB PCA frames to be transmitted; and
a common area queue, wherein, when one of the access categories gains a transmission opportunity (TXOP), the common area queue is assigned to that access category for storing UWB PCA frames to be transmitted.

11. The memory architecture of claim 10, wherein, when one of the access categories loses the TXOP, the UWB PCA frames stored in the common area queue are discarded and that access category releases the common area queue.

12. The memory architecture of claim 10, wherein the sizes of the pre-load queues and the common area queue are determined according to the throughputs of a producer and a consumer of the UWB PCA frames.

13. The memory architecture of claim 10, wherein the memory architecture is used in a media access control (MAC) sublayer.

14. The memory architecture of claim 13, wherein the UWB PCA frames are to be transmitted to a physical layer.
